(19) United States
(12) Patent Application Publication
(10) Pub. No.: US 2016/0281411 A1
(43) Pub. Date: Sep. 29, 2016

(54) Garage Door Controller

(71) Applicants: Leo John Calagaz, JR., Mobile, AL (US); James B. Busby, Mobile, AL (US); Joseph Stanley Hirst, III, Daphne, AL (US); Nathan O'Neil Miller, Mobile, AL (US); Rory Davis, Mobile, AL (US)

(72) Inventors: Leo John Calagaz, JR., Mobile, AL (US); James B. Busby, Mobile, AL (US); Joseph Stanley Hirst, III, Daphne, AL (US); Nathan O'Neil Miller, Mobile, AL (US); Rory Davis, Mobile, AL (US)

(21) Appl. No.: 15/081,834

(22) Filed: Mar. 25, 2016

Related U.S. Application Data
(60) Provisional application No. 62/138,817, filed on Mar. 26, 2015.

(51) Int. Cl. E05F 15/77; G01P 15/18; G05B 19/042; E05F 15/60

(52) U.S. Cl. CPC E05F 15/77; E05F 15/60; G01P 15/18; G05B 19/042; E05F 15/40

(57) ABSTRACT

A controller for a garage door opener monitors the load on the garage door opener motor, the current and voltage flow thereto, the status of the light on the garage door opener, the height of the door above closed position, the breakage of the light beam between the safety sensors and issues commands to the garage door opener motor to position the door at a height selected by the owner via his mobile device or a household computer connected to the network.

### FIELD OF INVENTION

The present invention relates to an aftermarket controller for a garage door opener that allows the garage door to operated and monitored remotely from a cell phone or other personal communication device connected to a wireless network.

### BRIEF DESCRIPTION OF THE DRAWINGS

Referring to the drawings which are appended hereto and which form a portion of this disclosure, it may be seen that:

FIG. 1 is a schematic diagram of our garage door controller interfacing with a garage door;

FIG. 2 is a diagrammatic view of a garage door showing alternative mounting locations for an accelerometer used to monitor the door.

FIG. 3 is a schematic diagram of the control line tie ins for the controller and the garage door opener.

FIG. 4 is a plan view of the controller housing and Y power supply cable;

FIG. 5 is a bottom view of the controller housing and Y power supply cable;

FIG. 6 is a schematic view of the controller circuit board located in the housing;

FIG. 7 is an exploded view of the controller;

FIG. 8 is an exploded view of the door mounted sensor; and,

FIG. 9 is a flow chart for the controller

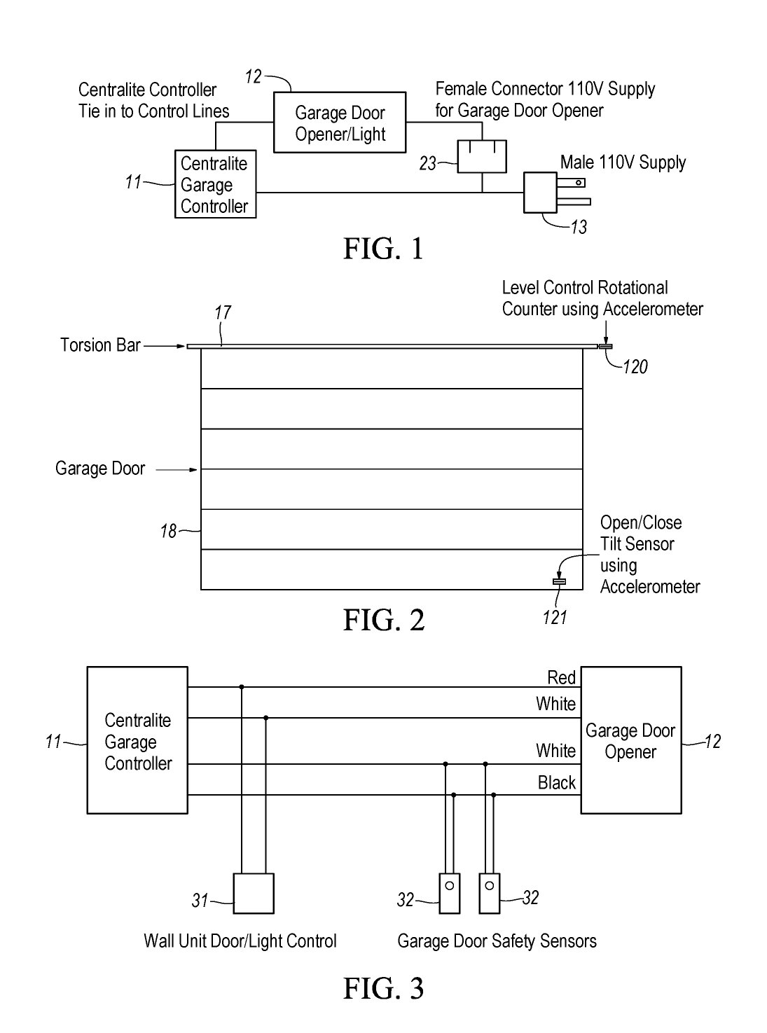

### DETAILED DESCRIPTION

Referring to the drawings for a clearer understanding of the invention, it may be seen that the present device is an add on for existing garage door openers that will economically provide owners of existing garage door openers with the benefit of having “smart” garage door opener. As is well known, garage door openers are typically activated from a wall unit or a remote control radio link that the owner uses while in a car leaving or approaching an associated drive way. Garage door openers include limit switches and well known controls for stopping the movement of the associated garage door at it fully up and fully down position. Additionally, light beam devices mounted near the floor adjacent the garage door are connected to the garage door opener to reverse the movement of the door or stop the movement of the door when an object is blocking the light beam. The present device uses these features as the base upon which a smart garage door opener is built.

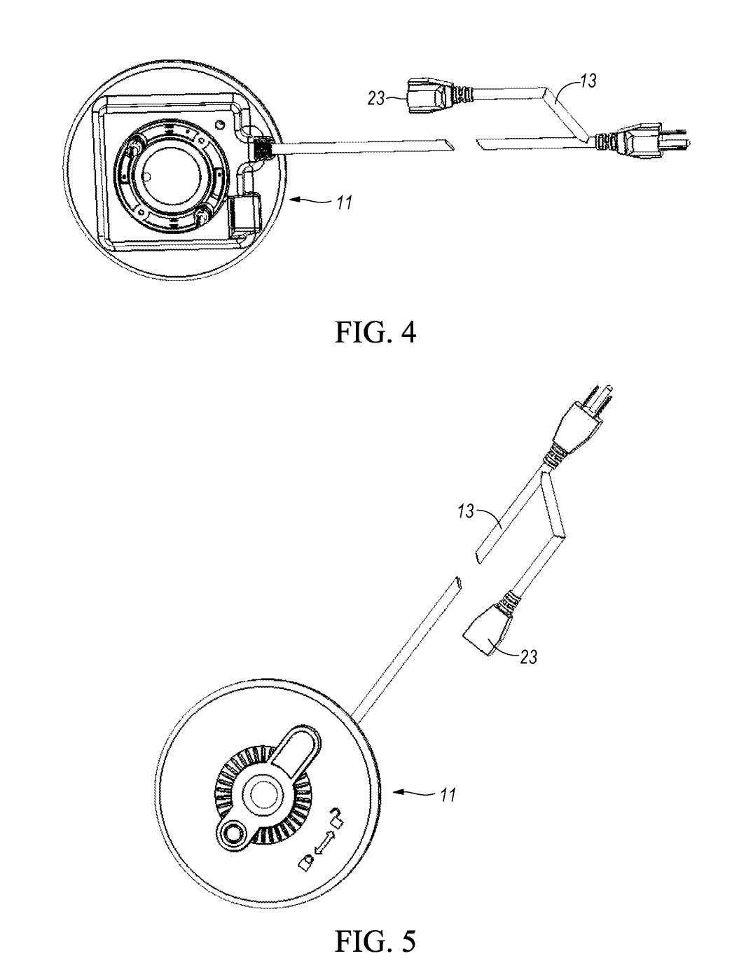

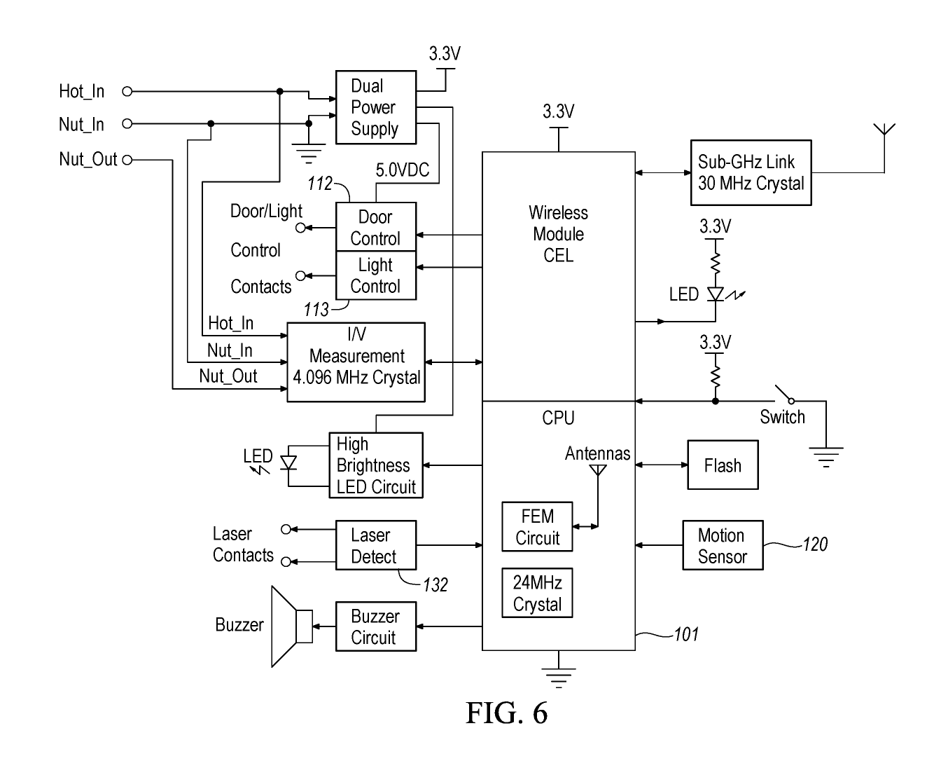

Most garage door openers come with a standard 110 volt plug for plugging into a conveniently located outlet on the ceiling superjacent the garage door. Our device utilizes a Y cable 13 shown in FIG. 4 which connects the garage door controller 11 and the garage door opener 12 to the 110 volt outlet by providing a female connector 23 in parallel with the garage door controller 11 such that the standard male plug 22 of the garage door opener connects to the female connector 23. This Y cable 13 supplies power to the controller 11 and gives the controller 11 access to the power circuit of the garage door opener 12 to provide a measuring point for the performance of the controller for purposes which will become evident later.

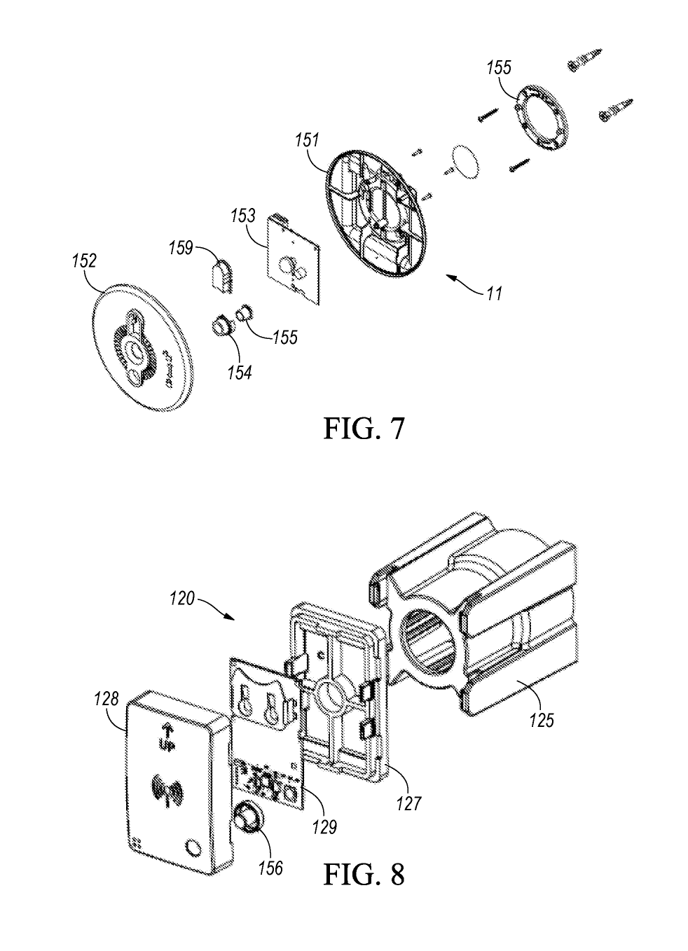

Referring to FIG. 7, note that garage door controller 11 includes a controller back cover 151, a controller front cover 152, a printed circuit board assembly 153 on which a microprocessor 101 and related electronics are mounted and housed within back and front covers 151, 152, a light pipe 154 from an led on the printed circuit board assembly 153, a diffuser, and a controller button 155 providing input to the printed circuit board assembly 153. A controller mounting ring or mounting bracket 154 is provided to releasably engage the back cover and mount the garage door controller to the ceiling or wall. The mounting bracket 154 is attached to the ceiling or wall using conventional screws and self-drilling dry wall anchors.

The garage door controller 11 uses microprocessor 101 to control the garage door opener in accordance with control communications from a user's cell phone or other wireless device through a home automation hub. Exemplary control components for controller 11 would be Silicon Labs' EM357 system-on-chip that integrates a 2.4 GHz, IEEE 802.15.4-2003-compliant transceiver, 32-bit ARM® Cortex™-M3 microprocessor, flash and RAM memory, and peripherals of ZigBee-based systems, such as home automation wireless networks. The integrated transceiver module, such as a ZICM35xSP2 available from California Eastern Laboratories, provides communication with a home automation unit using ZigBee HA 1.2 integration or similar radio frequency home integration capabilities. With onboard ZigBee HA 1.2 integration, the system can trigger other devices in the connected home such as lighting scenes, text notifications, and events as directed from a cellular telephone.

Referring to FIGS. 3 & 6, it will be noted that microprocessor 101 has input connections 131 for light control 31 and connection 112 to the garage door opener 12 as well as input 132 from the “laser” light beam safety sensors 32 mounted to either side of the door track. Such connections enable users to remotely raise/lower the garage door as well as turn on/off built-in garage door lights through the controller.

To enable the smart performance of the garage door opener, door movement information is needed beyond the basic open and closed information provided by the standard garage door opener. To this end, a garage door sensor 120 is employed to report to the microprocessor 101. The garage door sensor reports when the door is opened or closed and level of the door, if open. The sensor 120 includes an accelerometer 121, a microcontroller 122, and a transmitter 123. In an exemplary embodiment, we use a Microchip PIC16LF1618 microcontroller that receives acceleration data from an LIS331DLH high performance, ultra-low-power three-axis linear accelerometer to detect garage door movement. This acceleration data is converted to angular rotational data, and passed from the PIC16LF1618 microcontroller to the Silicon Labs Si4010 RF transmitter for transmission to the garage door controller to use for indicating garage door position. When the accelerometer 121 detects motion, it sends a “wake up” signal to the microcontroller 122 which enters a data sampling mode, and receives update signals from the accelerometer 121. This rotational data is used to determine whether the garage door is moving up or down, as well as angular degrees, and is passed to the transmitter for broadcast to the garage door controller 11.

Specifically, referring to FIG. 8, the garage door sensor 120 is mounted to the torsion bar 17 supplied with garage door 18 using torsion bar mount 125 which fits on either end of the torsion bar. Sensor housing 126, including back 127 and front 128 snaps onto mount 125 and house the sensor printed circuit board 129 which carries the electronic components. The sensor 120 is calibrated to the garage door after installation which allows the controller to determine the position of the door at any point of travel of the door from its fully closed position to its fully raised and open position.

Although we have described an accelerometer based system, it should be understood that we can also use a rotational counter mounted to the torsion bar to achieve the same control in a well-known manner. Such rotational counters may be based on a detectable physical anomaly such as one or more gaps in a disc, a magnetic anomaly, a reflective surface or any other like anomaly that may be detected as the torsion bar rotates. Mounted proximal the torsion bar in a cooperative position at a fixed point for sensing the anomaly 17 is a detector or sensor which will generate an electrical signal indicative of the position of the anomaly as it passes the fixed or reference point. The rotation of the torsion bar can be easily mathematically converted to the distance the door travels in either direction for calibration and control purposes. For directional control, two distinct anomalies sensed by different sensors may be employed with the direction determined by the order of detection of the anomaly.

In another embodiment, sensor 120 is mounted to the lower panel of the door. In this embodiment, torsion bar mount 125 is not used and sensor housing 126 is affixed to the door in the bottom panel of the door. The accelerometer 121 will indicate the start of any movement by the door and the garage door controller can be calibrated based on the time it takes the door to move from a stationary position to a stop at the fully raised and open position. In any described embodiment the controller 11 can stop the motor at any preset or selected position of the door between fully open and fully closed.

The garage door sensor 120 reports movement of the door, indicating whether the door is opened or closed and what level the door is at if open. By combining the output of sensor 120 and the status of the motor, an alarm may be triggered if the door has been moved without use of the motor. Further, if the door is open, the controller 11 can tell whether a person or thing has entered the garage by monitoring the safety beam sensor 32. Users will be able to send and receive text notifications or event alerts depending on the service platform they decide to use. Two of the most common use case scenarios include home break-in alerts when the garage door is opened manually without activating the motor, and automating safer and easier package deliveries where users remotely command the garage door to open to a few feet around time of delivery, then utilize a separate motion detector having a field of view within the garage adjacent the door to trigger the garage door to close after delivery.

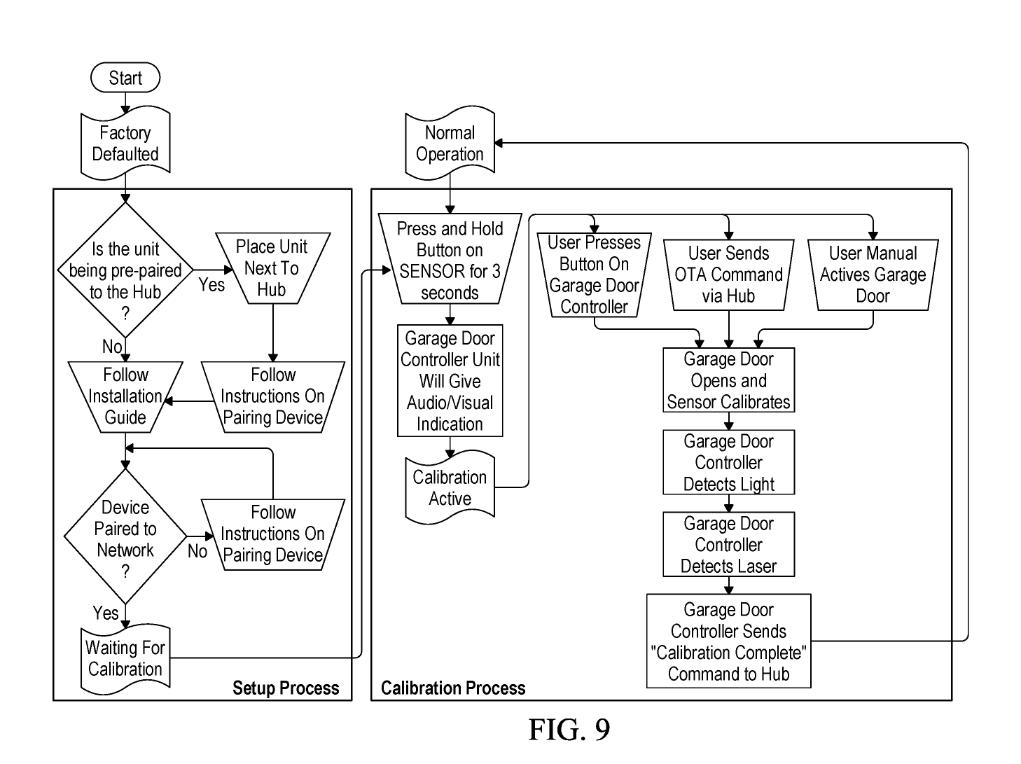

Use of the garage door controller is straightforward. Setup and operation generally follow the flow chart of FIG. 9. Locate torsion adapter and door sensor. If there is no torsion bar, skip the next two steps. Snap the door sensor into the torsion adapter. Attach torsion adapter to either side of garage door torsion bar. Place the controller 11 within 20 ft of a household hub for joining the hub. Depress the button 155 on the controller 11 while plugging into a 120 v outlet and upon power up, open the household hub for joining. After joining the hub, the controller 11 is ready to be connected to the garage door opener 12. Attach control wires to controller 11. Remove mounting bracket 154 from controller 11 and mount the bracket 154 to the ceiling using provided hardware. Attach control wires to motor making sure to color coordinate wire terminals on motor. Attach controller to the mounting bracket 154. Plug motor power supply in to Y cable female connector 23. Plug Y cable 13 into 120 v power supply at a wall or ceiling outlet. Using an existing garage door wall button or car remote, close the garage door and turn the motor light off. Push and hold door sensor button 156 for 3 seconds, controller 11 will beep and flash 3 times, release button 1565. (controller is now in calibration mode). Motor light should blink three times then remain on. Controller LED will now stay solid. (ready to calibrate door movement) Push wall button or car remote to open door. As the door opens the door sensor 120 is determining the travel of the door. The controller light will flash again after the door as completely opened informing you that calibration is completed.

While in the foregoing specification this device has been described in relation to certain embodiments thereof, and many details have been put forth for the purpose of illustration, it will be apparent to those skilled in the art that the invention is susceptible to additional embodiments and that certain of the details described herein can be varied considerably without departing from the basic principles of the invention.

What we claim is:

1. Apparatus for interfacing with a garage door opener to enable remote control of a garage door connected to said garage door opener comprising:
a. A programmable microprocessor for controlling the garage door opener to selectively position the garage door,
b. At least one garage door sensor for detecting movement of the garage door and providing an input relating to such movement to said programmable microprocessor;
c. A communication connection to a wireless network for allowing a user to program said microprocessor to control based said garage door opener based on predetermined events or communications received from said user, wherein said microprocessor utilizes the output of the garage door sensor to calibrate the movement of said garage door to determine the position of said garage door as said door selectively moves between an open and closed position.

2. Apparatus as defined in claim 1 wherein said garage door sensor further comprises, a microcontroller operably connected to an accelerometer for receiving signals therefrom and processing said signals to provide an input for said programmable microprocessor, and a transmitter, operably connected to said microcontroller to receive said input from said microcontroller and transmitting said input to said programmable microprocessor.

3. Apparatus as defined in claim 2, wherein said garage door sensor is mounted on said garage door.

4. Apparatus as defined in claim 2, wherein said garage door sensor is mounted on a torsion bar associated with said garage door.

5. Apparatus as defined in claim 1 wherein said garage door sensor further comprises, a microcontroller operably connected to an anomaly sensor for receiving signals therefrom and processing said signals to provide an input for said programmable microprocessor, and a transmitter, operably connected to said microcontroller to receive said input from said microcontroller and transmitting said input to said programmable microprocessor.

6. Apparatus as defined in claim 5, wherein said garage door sensor is mounted on a torsion bar associated with said garage door.

7. Apparatus as defined in claim 2 further comprising a motion detector having a field of view adjacent said garage door and having an output triggered by motion within said field of view, serving as an input to said programmable microprocessor.

8. Apparatus as defined in claim 2 further comprising an electrical current and voltage detector connected to said microprocessor and said garage door opener to signal said microprocessor as to load and electrical current status of said garage door opener.

9. Apparatus as defined in claim 6, wherein said microprocessor is programmed to determine electrical load as said garage door is moving to determine whether said door is being opened without energizing said garage door opener and to send an alarm to user via said wireless network.

10. Apparatus as defined in claim 1 further comprising a Y power supply cable having a male terminal for insertion into an electrical outlet located proximate said garage door opener and a first arm of the Y power supply cable connected to said microprocessor and a second arm terminating in a female connection for supplying power to said garage door opener.
